(19) United States
(12) Patent Application Publication
(10) Pub. No.: US 2014/0235011 A1
(43) Pub. Date: Aug. 21, 2014

(54) PROCESS OF MANUFACTURING OF THE CATALYTIC LAYER OF THE COUNTER-ELECTRODES OF DYE-SENSITIZED SOLAR CELLS

(71) Applicants: Thomas Meredith Brown, Rome (IT); Girolamo Mincuzzi, Rome (IT); Fabrizio Giordano, Rome (IT); Andrea Reale, Rome (IT); Aldo Di Carlo, Rome (IT)

(72) Inventors: Thomas Meredith Brown, Rome (IT); Girolamo Mincuzzi, Rome (IT); Fabrizio Giordano, Rome (IT); Andrea Reale, Rome (IT); Aldo Di Carlo, Rome (IT)

(73) Assignee: DYEPOWER, Roma (IT)

(21) Appl. No.: 14/239,631

(22) PCT Filed: Aug. 28, 2012
(86) PCT No.: PCT/IT2012/000262

§ 371 Date: Apr. 14, 2014

(30) Foreign Application Priority Data
Sep. 8, 2011 (IT) RM2011A000465

(51) Int. Cl. H01G 9/00

(52) U.S. Cl. CPC H01G 9/0029
USPC 438/98

(57) ABSTRACT

A process of manufacturing the catalytic layer of the counter-electrodes of dye-sensitized solar cells is described. The process has the following steps: depositing a catalyst precursor paste or precursor solution layer over the counter-electrodes conductive and transparent substrates, by screen printing, doctor blade, spin coating or brush,and irradiating the catalyst precursor paste or precursor solution layer with a continuous wave or pulsed laser beam having a wavelength in the range of infrared, visible, or ultraviolet, thus curing the precursor and forming a catalyst layer over the conductive and transparent counter-electrode substrates.

The present invention concerns a process of manufacturing of the catalytic layer of the counter-electrodes of dye-sensitized solar cells (DSCs).

In particular, the present invention concerns a process for laser curing the precursor for the catalytic layer of the counter-electrodes of dye-sensitized solar cells (DSCs).

DSCs are a promising photovoltaic technology with the potential of meeting the key requirements of being low cost and simple to fabricate.

DSCs are sandwich structures composed of active layers and two parallel electrodes. A photo-electrode is obtained by depositing over a transparent conducting substrate (either rigid or flexible) a large band-gap nanocrystalline semiconductor oxide (preferably TiO₂) by various techniques such as screen printing, doctor blade or spray pyrolisis. The TiO₂ layer is subsequently sintered to create electromechanical bonds between the nanoparticles.

A monolayer of a charge transfer dye that absorbs sunlight in the visible and sometimes near I.R. range is anchored on the TiO₂ layer. The dye is placed in contact with a redox electrolyte or an organic hole conductor. The former usually comprises of an organic solvent and an ionic redox system such as the iodide/triiodide couple or the Co(II)/Co(III) couple. Devices are completed with a counter-electrode consisting in general of a transparent and conductive substrate over which a catalyst layer (preferably made of Pt but also other alternatives including carbon based materials, and also Au for cobalt based electrolytes) is deposited. The average thickness of the Pt layer is between 0.1 nm and 500 nm, preferably between 0.5 nm and 100 nm. The device is sealed utilising thermoplastic gaskets, epoxy resins, or glass compounds such as glass frits.

After the photo-excitation of the dye molecule from the ground state S⁰ to the excited state S* induced by absorption of a photon, the excited electron is injected into the conduction band of TiO₂ and then migrates to the photoanode contact. The original state of the dye is subsequently restored by electron donation from the electrolyte. The regeneration of the dye sensitizer by iodide ions (the end reaction is the conversion of iodide into triiodide ions) prevents the recapture of the conduction band electron by the oxidized dye. The iodide is regenerated in turn by the reduction of triiodide at the counter-electrode, with the circuit being completed via electron being transported through the external load. The catalytic layer deposited on the counter-electrode has the crucial function of catalyzing the triiodide reduction.

One of the decisive aspects that determines cell performance is the formulation of the colloidal paste used for deposition of the nanocrystalline TiO₂ films and the subsequent thermal processing (i.e. sintering or annealing, or firing). The latter should guarantee good electromechanical bonding between nanoparticles (maximizing electron diffusion lengths) and a large surface area (maximizing dye sensitization and light harvesting). This trade off is conventionally obtained subjecting the film to a temperature profile with a final ˜30-45 min step at ˜450-500° C. in an oven or over an hotplate.

A crucial step in device fabrication is to obtain a catalyst layer showing an effective catalytic activity. The main catalyst layer is a thin layer of Pt (but also other alternatives including Au (for cobalt based electrolytes) and carbon based materials can be considered). Pt can be deposited by a sputtering process but is often attained after thermal processing of a Pt based precursor paste or solution. The possibility of depositing Pt through a liquid or viscous solution opens up the possibility of utilising screen printing, doctor blade, spin coating or other printing techniques for deposition over the counter-electrode. Sintering of the catalytic precursor layer is conventionally carried out utilizing an oven, furnace or hot plate subjecting the precursor layer to a temperature curing process with a final step of 5-30 minutes at 400-500° C.

A Pt-based catalytic precursor paste composition suitable for screen printing and doctor blade technique is preferably obtained mixing an organic carrier (e.g. terpineol), a binder or stabilizer (e.g. ethyl-cellulose) and a precursor (e.g. hexachloroplatinic acid H2PtCl6) (G. Khelashvili et al., Thin Solid Films 511-512 (2006) 342-348). According to N. Papageorgiou “Counter-electrode function in nanocrystalline photoelectrochemical cell configurations” Coordination Chemistry Reviews 248 (2004) 1421-1446, it is known that for “the catalytic CE, regardless of the preparation method can be described as follows: the catalyst is structurally characterized as nano-sized, pure platinum metal naked crystalline clusters or micro-crystallites, i.e. developed crystallites with exposed crystal or lattice planes, clearly visible under HR-TEM. These platinum nanocrystallites are microscopically polyhedral toward spherical in geometry, and are sparsely dispersed over the electrode substrate surface, the rest of the substrate being devoid of platinum, that is to say, there is no detectable platinum aside from the crystalline particles on the electrode surface (same analysis on an electro-deposited sample found Pt on the entire surface)”.

A less viscous alternative, suitable for solution processing techniques such as brush or spin coating, pad or ink jet printing, consists of a hexachloroplatinic acid solution in 2-propanol (D. Gutierrez-Tauste et al., Journal of Photochemistry and Photobiology A: Chemistry 175 (2005) 165-171). Other higher boiling points carriers can be utilised depending on the deposition technique.

Scanning laser processing has become a useful and ever more ubiquitous processing tool in industries including rapid prototyping, printing, polymer optoelectronics and thin film solar cells. It enables precise, low cost, local, selective, non-contact, scalable, and highly automated fabrication processes such as scribing, patterning, direct writing, marking, edge deletion, local melting, sintering, annealing and curing.

A raster scanning laser system (RSLS) can be a valid alternative industrial tool to carry out the firing of the TiO₂. Thermal processing by a RSLS consists in the local heating of the film that comes under the laser beam. Uniform processing over a large area can be achieved by scanning the laser beam over the selected surface. In the specific framework of DSCs, the use of a RSLS for the TiO₂ thermal processing has been already discussed in literature (H. Kim et al. Appl. Phys. A 83, 73-76 (2006); G. Mincuzzi et al., Appl. Phys. Lett. 95, 103312 (2009)). Developing a valid alternative to the conventional thermal processing procedure for the catalyst precursor paste, using a RSLS, would bring about the many advantages of laser processing listed above.

No laser sintering work has been proposed or carried out however on the Pt precursor for the counter-electrode of DSCs. Compared to the TiO₂ sintering the proposed process does not represent a straightforward development. There, the absorbing medium is the solid inorganic TiO₂ nanoparticle that has a precise and well known absorption coefficient that peaks strongly in the UV part of the electromagnetic spectrum. The catalyst precursor is instead composed of liquids and soft polymers dissolved or dispersed in the liquid carriers.

These advantages become particularly useful when scaling up to large area, when constructing dye solar cells integrated with other cells in photovoltaic modules or other devices in integrated optoelectronic applications. Furthermore, local heating can potentially be utilized on flexible substrates where conventional ovens would distort or decompose the plastic substrates [H. Kim et al. Appl. Phys. A 83, 73-76 (2006)]. If carried out carefully, local heating can overcome the problem by heating the layer to be sintered only, without degrading the underlying plastic substrates which can also have a protective layer (es SiOx) between the conducting oxide and the plastic film substrate.

Large area dye solar cell devices are obtained interconnecting unit cells to form modules which could in turn be interconnected to form a panel. Various interconnection architectures have been proposed for the modules, namely series-z, series-w, parallel and monolithic.

In particular, to increase the voltage output cells are connected together in modules via either z-series or w-series schemes. These interconnection designs amongst others, in fact are particularly attractive because the modules are potentially scalable to large dimensions avoiding the successive step of interconnection and integration of separate cells into a panel drastically simplifying the fabrication process compared to crystalline silicon panels. In DSCs the cells and interconnects can be integrated together by simple printing processes.

In z-series design unit cells are sealed and connected by means of conductive vertical interconnections. The advantages of this design are a high voltage output and ease of carrying out any pre- and post-treatment of the electrodes that may be required. The disadvantage is the risk of fill factor lowering resulting from the series resistance of the interconnections. A crucial aspect is the fabrication and realization of thermally stable vertical interconnections. Such interconnections need also to be protected from the corrosion caused by the redox electrolyte, which could compromise the modules performance and life time. An efficient and reliable interconnection strategy for z-series connected modules is a still open technological challenge while some solutions have been proposed and disclosed, amongst the other, in US2006243587 and in JP2006294423.

Differently from the z-series, the w scheme avoids interconnects altogether by juxtaposing cells facing in one direction with cells facing the opposite direction i.e. that have working electrode/counter-electrodes in opposite alternation. However, the w scheme still requires separation of the cells by an effective seal. The design has advantages in simplicity and avoids the reduction in fill factor resulting from additional resistance of series interconnects, especially when the modules operate at high temperatures, but has some manufacturing and performance weaknesses. In manufacturing of this design, it is necessary that the counter-electrode and working electrode are each processed on the same substrate. When conventional fabrication methods are utilized, this introduces processing complexities in deposition, curing, pre- and post-curing treatments of the cells materials, in particular TiO₂ and catalyst precursor paste.

Moreover, the following issues are still open.

It has been shown in literature that performances of unit cells (in particular Jsc, Voc and power conversion efficiency) undergo a dramatic improvement after a TiO₂ treatment with TiCl₄ (reference ITO). To utilize the same treatment for w connected modules, the utilization of masks protecting the catalyst layer becomes mandatory. The protective masks are necessary because the treatment damages the catalytic properties of the counter-electrodes: an increase of the catalyst equivalent series resistance with a consequent significant decrease of the module fill factor is observed.

Other treatments on the TiO₂ layer may also damage the catalyst if this is deposited on the same substrate as happens in w modules. For example, Lee et al. (Current Applied Physics 9 (2009) 404-408) demonstrate that an U.V.-O₃ treatment before and after annealing the TiO₂ results in a significant (10%) increase of cell performance. Such treatments carried out on the TiO₂ layer may ruin the catalytic properties of the neighbouring Pt counter-electrodes in w-series modules without masking.

Importantly, when one makes a DSC module, the main process carried out to anchor the dye to the TiO₂ films is that of submerging the substrate in a solution containing dye. In the case of w-series modules, the dye solution would also come in contact with the Pt layer, which can produce poisoning effects reducing the catalytic properties of such layer.

A further aspect is connected with the possibility of integrating DSCs into building façades. The integration of electrochemical devices in buildings is well known. For example, US2003/20053A discloses an electrochemical layer comprising a polymeric matrix containing an electrochromic solution. One of the peculiar characteristics of DSCs is the transparency, which make this technology appealing for building façades integration, independently from the interconnection strategy adopted. It has been observed that the conventional thermal treatments required for TiO₂ and the catalyst layer can cause deformations of glass substrates surface and a substantial loss of glass planarity. This will lead to unwanted irregular sun light reflections when façade integrated DSCs panels are exposed to sun light, significantly reducing their architectural and esthetical appeal. Furthermore glass non-planarity makes difficult or prevents the fabrication of modules over significantly large areas. These problems outlined above could be prevented by using RSLS.

Laser thermal processing of liquid molecular chemical precursors and colloidal or particle suspensions for electronic and microelectronic purpose has been suggested and enclosed in WO2005/039814 and in patents cited therein.

US2010/0034986A1 discloses the deposition of a great number of conductive and precursor inks including Pt (or Au) based ones, including the laser treatment of the inks and possible applications for flexible DSCs. Nevertheless, US2010/0034986A1 refers to conductive electrodes, the structure of which is completely different from that of a catalytic layer which needs to be also transparent and is thus not suitable as catalytic layer for transparent or semi-transparent dye solar cell devices. In fact, increasing the layer thickness results in higher conductivity but also in lower transparency.

An aim of the present invention is therefore that of proposing a process of manufacturing transparent or semi-transparent catalytic layers of the counter-electrodes of DSCs (in particular Pt (or even Au) based catalytic layers but not limited to), allowing to overcome the limits of the solutions of the prior art and achieving the above technical results.

A further aim of the invention is that said process can be operated with substantially low costs.

Not last one aim of the invention is that of proposing a process of laser curing the precursor for the counter-electrode of DSCs which is substantially simple, safe and reliable.

It is therefore a specific object of the present invention a process of manufacturing the catalytic layer of the counter-electrodes of dye-sensitized solar cells (in particular Pt (or Au) based catalytic layers but not limited to), comprising the following steps:

depositing a catalyst precursor paste or precursor solution layer over the counter-electrode conductive and transparent substrates, by screen printing, doctor blade, spin coating or brush;

irradiating said catalyst precursor paste or precursor solution layer with a C.W. or pulsed laser beam having a wavelength in the range of infrared (CO₂, Nd:YAG, Nd:YVO₄, Yb doped fiber) visible (frequency doubled Nd:YAG, Nd:YVO₄, Yb doped fiber) or ultraviolet (frequency tripled Nd:YAG, Nd:YVO₄, Yb doped fiber), thus curing said precursor and forming a catalyst layer over the conductive and transparent counter-electrode substrates.

Further objects of the present invention are specified in the following dependent claims.

In particular, according to the present invention, an essential feature for obtaining a transparent catalytic layer is that the average thickness of said catalytic layer is lower than 300 nm, preferably lower than 20 nm, most preferably comprised between 0.5 nm and 10 nm.

Preferably, according to the invention, dyes that absorb strongly at the laser wavelength can further be added to the precursor paste or solution, these dyes developing heat and assisting in curing the precursors of said layer.

The present invention will be described in the following for illustrative non limitative purposes, according to a preferred embodiment, with reference to the following drawings, wherein:

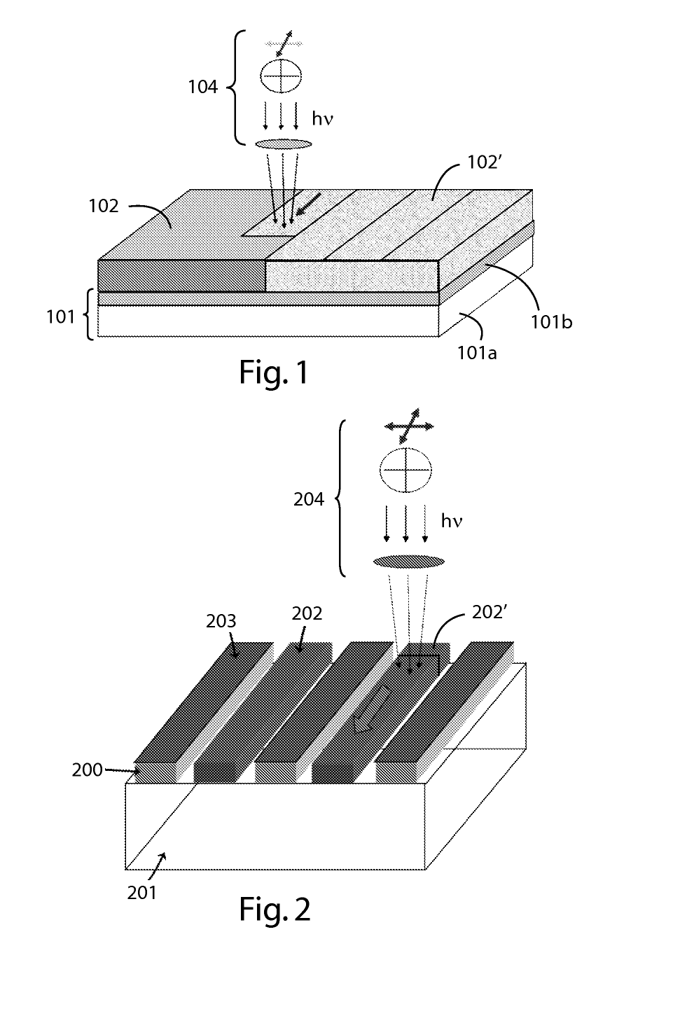

FIG. 1 shows a schematic representation of the process of manufacturing the catalytic layer of the counter-electrodes of dye-sensitized solar cells according to a first embodiment of the present invention,

FIG. 2 shows a schematic representation of the process of manufacturing the catalytic layer of the counter-electrodes of dye-sensitized solar cells according to a second embodiment of the present invention,

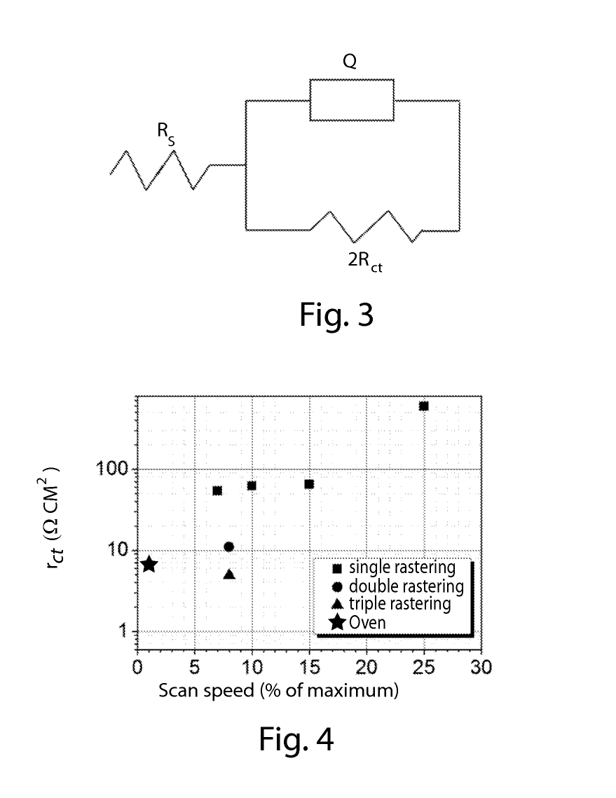

FIG. 3 shows the cell equivalent circuit diagram of symmetric cells according to example 1,

FIG. 4 shows the calculated R_{ct} values as a function of the scan speed according to example 1,

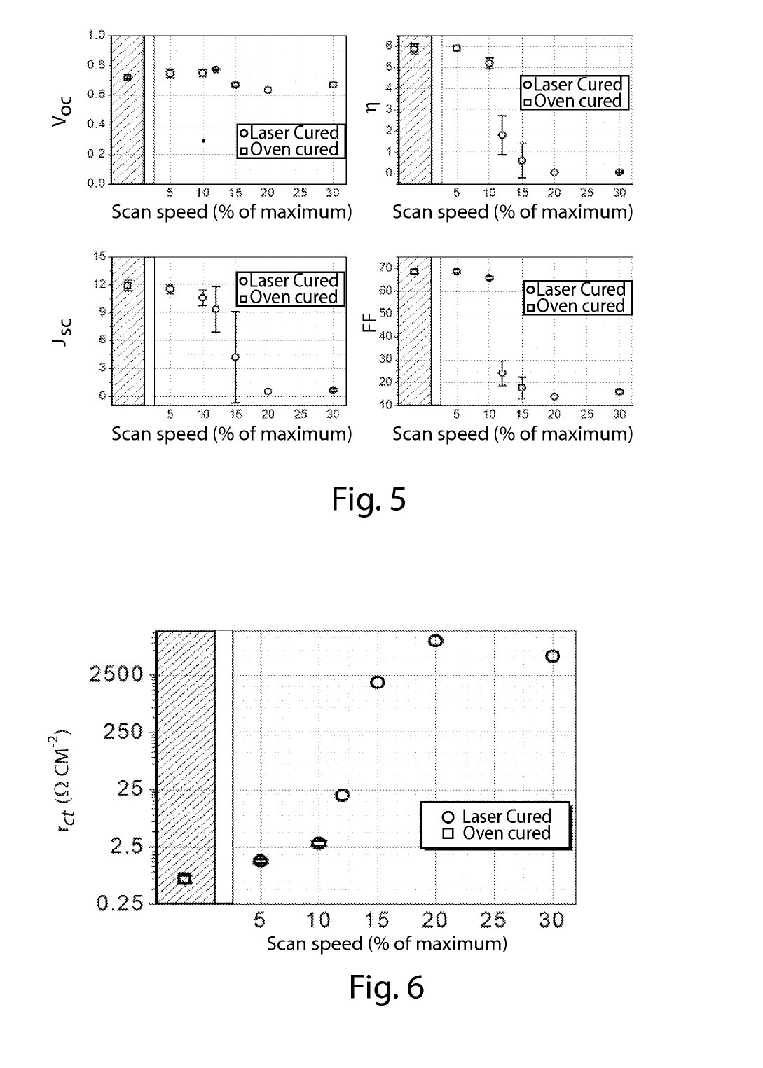

FIG. 5 shows the characteristics electrical parameters vs. the scan speed of the DSC according to example 2, and

FIG. 6 shows the values of R_{ct} obtained by Electro Impedance Spectroscopy (EIS) measurement in example 2.

According to this present invention the use of a RSLS is applied for the first time to the thermal treatment of the DSCs catalyst precursor paste and/or solution. In particular, but not limited to, to the thermal treatment of a Pt based precursor paste or solution based on a liquid platinic acid precursor. Differently from the process proposed in the literature and in particular in WO2005/039814, according to the present invention a precursor paste or solution for the counter-electrode is used whose active ingredient is a liquid platinic acid that can be mixed with other solvents (for solutions and pastes) and organic binders (for viscous pastes) and that leads to a thin (preferable<=10 nm) and (semi)transparent layer growing in islands, crystallites or clusters which is generally non-conducting or very poorly conductive. Differently from the process of US2010/0034986A1, by which a conductive layer is formed, according to the present invention a liquid precursor is used, a Pt based precursor paste or solution based on a liquid precursor, which does not initially contain any particle or solid compound of Pt and having a lower thickness. This is important in order to obtain a catalyst layer which is structurally characterized as nano-sized, platinum grown in islands, crystalline clusters or micro-crystallites.

According to the present invention, when irradiated by the laser beam, the carriers will evaporate or decompose, the binders decompose and the precursor convert into a solid Pt layer (thus even changing the absorption characteristics during the process).

RSLS, being a local heating process permits the firing of the catalyst layer being carried out separately (in time and in space) from that of the TiO₂ layer and significantly independently of the processes carried out on the TiO₂ layer such as the anchoring of the photoactive dye. One can deposit the TiO₂ layer, sinter it (via conventional furnaces/ovens or via RSLS), apply the various treatments, anchor the dye and then deposit the precursor catalyst layer. Subsequently one can locally heat the precursor layer via RSLS to convert it into the final catalyst required for the proper functioning of the cell. This would have many advantages including avoiding the use of masks over the Pt layer when processing the TiO₂ layer, maintain the planarity of the glass substrates, the possibility of effective firing on glass substrates and integrating DSC modules with other devices on a single substrate and finally the possibility of using flexible plastic substrates instead of metallic or glass ones.

According to the present invention, for DSC counter-electrodes fabrication (see FIG. 1), over a conductive and transparent substrates (glass or plastic) (101) (composed of a glass or PET or PEN substrate 101a underlying a transparent conductive oxide layer 101b) a catalyst layer (102′) preferably (but not limited to) from ˜1 nm to few hundred nanometers thick is obtained.

According to the present invention a catalyst precursor paste or precursor solution layer (102) can be deposited over the conductive and transparent substrates (101) by screen printing, doctor blade, spin coating or brush.

According to the prior art, the subsequent thermal treatment (e.g. curing or annealing or firing) required to obtain the final catalyst layer from the precursor paste or precursor solution would be carried out subjecting substrate (101) and precursor layer (102) to a time increasing temperature with a final firing step of 5-30 minutes at 400-450° C. into an oven or furnace or over an hot plate.

According to the present invention the catalyst layer (102′) is obtained by the precursor paste or precursor solution (102) irradiating the latter with a C.W. or pulsed laser beam (104) having a wavelength in the range of infrared (CO₂, Nd:YAG, Nd:YVO₄, Yb doped fiber) visible (frequency doubled Nd:YAG, Nd:YVO₄, Yb doped fiber) or ultraviolet (frequency tripled Nd:YAG, Nd:YVO₄, Yb doped fiber). This will produce a local heating of the precursor paste (102) and the suitable temperature for the Pt-layer to be obtained will be reached.

Advantageously, dyes that absorb strongly at the laser wavelength can further be added to the precursor paste or solution, with these dyes developing heat and assisting the curing of the precursor paste or solution.

A complete annealing or curing or firing of the precursor layer (102) is obtained by rastering the laser beam (104) over the whole surface. An effective annealing or curing or firing is obtained by choosing the right combination of the RSLS parameter (average power, pulse length, pulse energy, beam dimensions, scan speed, and integrated laser fluence) during the rastering which depend on the precursor paste formulation and thickness.

The aim of the invention is to provide a method for the manufacture of DSCs and DSCs modules counter-electrodes having an effective catalytic layer. The catalytic layer is preferably made of Pt but not limited to. Such catalytic layer is obtained after a thermal treatment (also referred as curing or annealing or firing) of a precursor layer by means of a Raster Scanning Laser System as an alternative of the conventional oven, furnaces or hotplates.

Various molecular precursors can be used for platinum metal. Preferred molecular precursors include ammonium salts of platinates such as ammonium hexachloro platinate (NH₄)₂PtCl₆, and ammonium tetrachloro platinate (NH₄)₂PtCl₄; sodium and potassium salts of halogeno, pseudohalogeno or nitrito platinates such as potassium hexachloro platinate K₂PtCl₆, sodium tetrachloro platinate Na₂PtCl₄, potassium hexabromo platinate K₂PtBr₆, potassium tetranitrito platinate K₂Pt(NO₂)₄; dihydrogen salts of hydroxo or halogeno platinates such as hexachloro platinic acid H₂PtCl₆, hexabromo platinic acid H₂PtBr₆, dihydrogen hexahydroxo platinate H₂Pt(OH)₆; diammine and tetraammine platinum compounds such as diammine platinum chloride Pt(NH₃)₂Cl₂, tetraammine platinum chloride [Pt(NH₃)₄]Cl₂, tetraammine platinum hydroxide [Pt(NH₃)4(OH)₂, tetraammine platinum nitrite [Pt(NH₃)₄](NO₂)₂, tetrammine platinum nitrate Pt(NH₃)₄(NO₃)₂, tetrammine platinum bicarbonate [Pt(NH₃)₄](HCO₃)₂, tetraammine platinum tetrachloroplatinate [Pt(NH₃)₄]PtCl₄; platinum diketonates such as platinum (II) 2,4-pentanedionate Pt(C₅H₇O₂)₂; platinum nitrates such as dihydrogen hexahydroxo platinate H₂Pt(OH)₆ acidified with nitric acid; other platinum salts such as Pt-sulfite and Pt-oxalate; and platinum salts comprising other N-donor ligands such as [Pt(CN)₆]⁴⁺.

Platinum precursors useful in organic-based precursor compositions include Pt-carboxylates or mixed carboxylates. Examples of carboxylates include Pt-formate, Pt-acetate, Pt-propionate, Pt-benzoate, Pt-stearate, Pt-neodecanoate. Other precursors useful in organic vehicles include aminoorgano platinum compounds including Pt(diaminopropane)(ethylhexanoate).

Preferred combinations of platinum precursors and solvents include: PtCl₄ in H₂O or ethanol or higher boiling point alcohols like isopropyl alcohol and mixture of these with H₂O; Pt-nitrate solution from H₂Pt(OH)₆; H₂Pt(OH)₆ in H₂O or ethanol or higher boiling point alcohols like isopropyl alcohol and mixture of these with H₂O; H₂PtCl₆ in H₂O or ethanol or higher boiling point alcohols like isopropyl alcohol and mixture of these with H₂O; and [Pt(NH₃)₄](NO₃)₂ in H₂O or ethanol or higher boiling point alcohols like isopropyl alcohol and mixture of these with H₂O.

Gold precursors useful for organic based formulations include: Au-thiolates, Au-carboxylates such as Au-acetate Au(O₂CCH₃)₃; aminoorgano gold carboxylates such as imidazole gold ethylhexanoate; mixed gold carboxylates such as gold hydroxide acetate isobutyrate; Au-thiocarboxylates and Au-dithiocarboxylates.

The catalytic layer can also be made of carbon based materials. A particularly suitable carbon based material is carbon black.

In case the catalyst precursor paste or precursor solution layer (102) is deposited over the conductive and transparent substrates (101) by printing methods that require viscous pastes, like screen printing or doctor blade, a preferred Pt-based catalytic precursor paste composition is obtained (but not limited to) mixing organic carriers (e.g. terpineol), a binder or stabilizer (e.g. ethyl-cellulose) and a precursor (e.g. exachloroplatinic acid).

Instead, in case the catalyst precursor paste or precursor solution layer (102) is deposited over the conductive and transparent substrates (101) by printing techniques that require non-viscous inks, such as spin or brush coating or ink-jet printing, an hexachloroplatinic acid solution in 2-propanol is preferably used (but not limited to). Higher boiling point solvents can be used depending on deposition technique.

According to the present invention, for the subsequent thermal process, which reduces the precursor in its final solid form as a catalytic layer, RSLS is used. RSLSs are generally adopted as industrial tools for the thermal processing of materials in solid state of which the absorption spectrum is known. Reference is made in particular to process as free-form casting, sintering of μm-, nm-sized particles of metals, oxides, ceramics etc. showing a strong absorption for particular wavelengths range or even single wavelength. RSLS utilizes a wavelength strongly absorbed by the materials considered. During the process, particles under the beam are heated after the laser photon absorption via thermalization and electron-phonon collisions. The desired inter-particles necking level and temperature will be reached into the material without it suffers any substantial physical change.

Laser thermal processing of liquid molecular chemical precursors and colloidal or particle suspensions for electronic and microelectronic purpose has been disclosed in WO2005/039814.

According to the present invention, the use of a RSLS is extended for the first time to the thermal treatment of the DSCs catalyst precursor paste or catalyst precursor solution, in particular, but not limited to, to the thermal treatment of a Pt based precursor paste or precursor solution having the compositions reported above. Differently from usually thermally treated materials, the precursor paste or solution is a mix of various components in different physical states as liquid or colloid included.

According to the present invention, when irradiated by the laser beam, some of them will evaporate or decompose (e.g. organic carriers and binders) and some will transform (precursor) leading to a dramatic variation of the absorption spectrum. As a consequence, there is not a peculiar laser beam wavelengths range which is particularly suitable for the process.

According to the present invention, the RSLS is based on a C.W. or pulsed laser having a wavelength in the range of infrared (preferably but not limited to CO₂, Nd:YAG, Nd:YVO₄, Yb doped fiber) visible (preferably but not limited to frequency doubled Nd:YAG, Nd:YVO₄, Yb doped fiber) or ultraviolet (preferably but not limited to frequency tripled Nd:YAG, Nd:YVO₄, Yb doped fiber, excimer laser). By irradiating with the laser the precursor paste or the precursor solution, a local heating is produced and the suitable temperature for the carrier and binder evaporation and the precursor to final catalyst layer transformation will be reached. An effective and complete thermal processing (annealing or curing or firing) of the precursor paste or precursor solution (102) is obtained by rastering the laser beam (104) over the desired surface and, importantly, by choosing the right combination of the laser system parameters (average power, pulse length, pulse energy, beam dimensions, integrated laser fluence, scan speed) which depend on the precursor paste or precursor solution formulation and thickness.

For w-series module fabrication, the present invention is particularly useful in separating the processing of the working electrode films from that of the counter-electrode layers (see FIG. 2).

According to the present invention, for the fabrication of w-series connected DSC modules, a large band-gap nanocrystalline semiconductor oxide (preferably TiO₂ but not limited to) colloidal paste (200) is deposited onto a transparent and conductive substrate (201) by various techniques such as screen printing, doctor blade, spray pyrolysis, spray casting in a modular geometry similar (but not limited to) that of FIG. 2.

According to the prior art, in order to fabricate these modules, the counter electrode precursor layer (202) would be deposited either before or after deposition of the TiO₂ layer and the two sintered together. It would be also possible to deposit one layer, carry out sintering and then deposit the second and carry out a second sintering step. However, in all cases, sintering would occur before application of dye.

The present invention makes it possible to cure the counter-electrode catalytic layer after application of dye or other treatments over the TiO₂ covered substrate.

After its deposition, the TiO₂ colloidal layer is subjected to a sintering procedure which can be optimized for this particular layer utilizing oven, furnace or hotplates or other techniques (e.g. laser sintering) which leads to the required mesoporous nanocrystalline films.

Since according to the present invention it has become possible to deposit and sinter the Pt layer on the same substrate after any desired treatment required for the TiO₂ film, since sintering is carried out locally on the Pt precursor-covered regions only, it is possible to carry out beneficial treatments such as TiCl₄ and UV-O₃ treatments.

According to the present invention, after application of the dye monolayer (203) to the TiO₂ film (e.g. by immerging the substrate into a solution of dye) and rinsing the excess dye from the regions of the substrate which are not covered by the TiO₂ cells, the catalytic precursor solution is deposited.

According to the present invention a precursor paste (202) (having for instance the same composition mentioned above) is deposited in alternation to the TiO₂ working electrodes (200) over the same substrate (201) and subsequently thermally treated by a RSLS (204), thus forming the catalyst layer (202’). Using RSLS, no masking is needed, for example when carrying out the dyeing procedure.

### EXAMPLE 1

As an example of how to process the Pt layer it is possible to start by measuring the counter-electrode/electrolyte charge transfer resistance R_{ct}. In fact, R_{ct} is inversely proportional to the counter-electrode/electrolyte exchange current density and is one of the most significant parameter to consider for evaluate the effectiveness of the catalytic activity performed by the Pt layer (T. N. Murakami, M. Graetzel/Inorganica Chimica Acta 361 (2008) 572-580). The R_{ct} and therefore the catalytic activity produced by a particular layer can be gauged by using Electro Impedance Spectroscopy (EIS) methods (A. Hauch, A. Georg/Electrochimica Acta 46 (2001) 3457-3466). In order for good catalysis of the ionic species the R_{ct} is expected to be of the order of some Ohm/o cm-2 (J. M. Kroon et al., Prog. Photovoltaics 15, 1 (2007)). In order to measure or extract R_{ct} it is sufficient and particularly useful to work on symmetric cells. In fact, in this case R_{ct} is obtained as the value that performs the best fitting of the cell Nyquist diagram considering the cell equivalent circuit diagram sketched in FIG. 3 (A. Hauch, A. Georg/Electrochimica Acta 46 (2001) 3457-3466)

A batch of symmetric cells composed by two identical counter electrodes was realized. The batch is composed by two set of cells (i) and (ii). For the counter-electrodes fabrications substrates (2 cm×2 cm, 8 Ohm/□) were first cleaned in acetone and ethanol. A layer of Pt precursor paste (Pt catalyst Solaronix) was deposited over the whole surface by doctor blade technique using a gap of 50 μm. For set (i), the Pt precursor paste thermal treatment was carried out using a RSLS based on a CO₂ laser. The laser power (20 W), defocusing (10.4 cm) e scanning lines overlap (maximum performed by the system) were fixed while various scan speeds were considered. For set (ii) the treatment was performed into an oven subjecting the precursor paste to a time increasing temperature with a final step of 30 minutes at 400° C. Symmetric cells were completed by sealing (with a gasket 7 mm×7 mm) electrodes obtained with the same curing conditions and injecting (by vacuum filling) an electrolyte based on the iodide/triiodide redox couple (High Stability Electrolyte HSE, DyeSol). EIS measurements were performed in dark over the frequency range of 300 kHz 50 mHz.

In FIG. 4 are reported the calculated R_{ct} values as a function of the scan speed (expressed as % of the maximum scan speed performed by the used system which is 30 cms⁻¹) for the above mentioned values of laser power, defocusing and scanning lines overlap. Also shown is the R_{ct} value (star) obtained by a cell of set (ii) with a conventional oven processing.

As the scan speed decreases, the average energy density deposited by the laser into the precursor layer increases and a higher temperature is locally achieved determining a decreasing on the R_{ct}. An effective thermal treatment (or annealing or curing or firing) of the precursor paste was obtained after a triple rastering (triangle) with a scan speed equal to the 7% of the maximum performed by the RSLS. In this case, an R_{ct} value of 5 Ohm/□ was obtained, indicating that a good catalysis level was achieved. Such value equals the one extracted by the conventionally oven treated cell.

### EXAMPLE 2

As a further example a batch of DSCs was realized. The batch is in turn composed of two set (i) and (ii). The substrates were F-doped SnO₂ (FTO)-coated soda lime (2 cm×2 cm; 8 Ω/□; Mansolar) cleaned using ultrasonic baths in acetone and ethanol. 0.5 cm×0.5 cm TiO₂ films were deposited via screen printing using DyeSol 18 NRT paste, then sintered into an oven with a last firing step at 525° C. and subsequently put into a 0.5 mM N719 (Dyesol) dye solution in ethanol overnight. After soaking in the dye solution the substrates were rinsed in ethanol. Counter-electrodes were prepared depositing by brush a Pt precursor solution (Platisol, Solaronix) onto the FTO-coated substrates. Counter-electrodes of the set (i) where annealed over an hot plate whit a final firing step at 400° C. for 5 minutes. Pt precursor paste of set (ii) counter-electrodes were cured using a RSLS based on a 20 W CO₂ laser. The laser power (20 W), defocusing (10.4 cm) e scanning lines overlap (maximum performed by the system) were fixed while various scan speeds were considered. The cells of both sets were completed by sealing together the two electrodes via a 60 μm thick Surlyn gaskets. An electrolyte (HSE DyeSol) was inserted into the cell via vacuum backfilling. All the devices were tested under a sun simulator (Solar constant 1200 KHS) at AM 1.5 1000 W/m² calibrated with a Skye SKS 1110 sensor. In FIG. 5 are reported the characteristics electrical parameters vs. the scan speed (expressed as % of the maximum scan speed performed by the system which is 30 cms⁻¹). Starting from relatively high scan speed (around 30% of the maximum scan speed), the power conversion efficiency η, the short circuit current Jsc and the Fill Factor FF are very low. Values of these parameters observe a threshold at around 15% of scan speed, switching to higher values which are equal, into the experimental errors, to the value extracted from cells fabricated with a counter-electrode cured over a hot-plate. The best cell with a counter-electrode laser cured reach an efficiency of ≈6%, a J_{sc} of ≈12 mA cm⁻² and a FF of ≈70%. The Voc values are less affected by the scan speed observing a relative variation<15%.

In FIG. 6 are reported the values we extracted of R_{ct} from EIS measurement. When the scan speed is relatively high, R_{ct} is very high and observes a threshold behavior at around 15% of scan speed, where drop to some ohm reaching a minimum of around 1.5 ohm at 5% of scan speed. While this value is quite two times the one extracted from cells with counter-electrode cured over an hot plate (which is ≈0.75 ohm), such difference does not affect sensibly the final cell power conversion efficiency.

The present invention was disclosed for illustrative, non limitative purposes, according to preferred embodiments thereof, but it is to be understood that variations and/or modifications could be introduced by those skilled in the art without departing from the relevant scope of protection as defined by the enclosed claims.

1. A process of manufacturing a catalytic layer of counter-electrodes of dye-sensitized solar cells, comprising the following steps:
depositing a catalyst precursor paste or precursor solution layer over the counter-electrode conductive and transparent substrates, by screen printing, doctor blade, spin coating or brush; and
irradiating said catalyst precursor paste or precursor solution layer with a continuous wave or pulsed laser beam having a wavelength in the range of infrared, (CO₂, Nd:YAG, Nd:YVO₄, Yb doped fiber) visible, (frequency doubled Nd:YAG, Nd:YVO₄, Yb doped fiber) or ultraviolet (frequency tripled Nd:YAG, Nd:YVO₄, Yb doped fiber), curing said precursor and forming a catalyst layer over the conductive and transparent counter-electrode substrates.

2. The process of manufacturing the catalytic layer of counter-electrodes of dye-sensitized solar cells according to claim 1, wherein said catalyst precursor paste or precursor solution layer comprises dyes that absorb strongly at the laser wavelength.

3. The process of manufacturing the catalytic layer of counter-electrodes of dye-sensitized solar cells according to claim 1, wherein said irradiating step is performed by rastering the laser beam over a whole surface of the catalyst precursor paste or precursor solution layer.

4. The process of manufacturing the catalytic layer of counter-electrodes of dye-sensitized solar cells according to claim 1, wherein said irradiating step is performed with a CO₂ laser.

5. The process of manufacturing the catalytic layer of counter-electrodes of dye-sensitized solar cells according to claim 1, wherein an average thickness of said catalytic layer ranges from 0.1 nm to 300 nm.

6. The process of manufacturing the catalytic layer of counter-electrodes of dye-sensitized solar cells according to claim 5, wherein the average thickness of said catalytic layer ranges from 0.1 nm to 20 nm.

7. The process of manufacturing of the catalytic layer of the counter-electrodes of dye-sensitized solar cells according to claim 6, wherein said catalytic layer is from 0.5 nm to 10 nm thick.

8. The process of manufacturing the catalytic layer of counter-electrodes of dye-sensitized solar cells according to claim 1, wherein said catalytic layer is based on platinum.

9. The process of manufacturing the catalytic layer of counter-electrodes of dye-sensitized solar cells according to claim 1, wherein said catalytic layer is based on gold.

10. The process of manufacturing the catalytic layer of counter-electrodes of dye-sensitized solar cells according to claim 1, wherein said catalytic layer is composed of a carbon based material.

11. The process of manufacturing the catalytic layer of counter-electrodes of dye-sensitized solar cells according to claim 10, wherein said carbon based material is carbon black.

12. The process of manufacturing the catalytic layer of counter-electrodes of dye-sensitized solar cells according to claim 8, wherein said catalyst layer is structurally composed of nano-sized, pure platinum metal naked crystalline clusters or micro-crystallites.

13. The process of manufacturing the catalytic layer of counter-electrodes of dye-sensitized solar cells according to claim 8, wherein, when deposited by screen printing and doctor blade technique, the platinum-based catalytic precursor paste or solution composition is obtained mixing an organic carrier (e.g. terpineol), a binder or stabilizer (e.g. ethyl-cellulose) and a precursor (e.g. hexachloroplatinic acid), while, when deposited by spin coating or brush, the platinum-based catalytic precursor paste or solution composition is an hexachloroplatinic acid solution in 2-propanol.

14. The process of manufacturing the catalytic layer of counter-electrodes of dye-sensitized solar cells according to claim 1, wherein, when fabrication of w-series connected dye-sensitized solar cells (DSC modules is realised, the process further comprises, before said step of catalyst precursor paste or precursor solution layer deposition, the following steps:
depositing a large band-gap nanocrystalline semiconductor oxide (e.g. TiO₂) colloidal paste layer over said transparent and conductive substrate, by screen printing, doctor blade, spray pyrolysis or spray casting, in a modular geometry suitable for w-series connection,
sintering said semiconductor oxide (e.g. TiO₂) colloidal paste, by conventional furnaces, ovens or hotplates or by a raster scanning laser system, thus forming bands of a semiconductor oxide film having modular geometry,
applying a dye monolayer to the semiconductor oxide film, and
rinsing excess dye from regions of the substrate which are not covered by the bands of semiconductor oxide film,
wherein said step of catalyst precursor paste or precursor solution layer deposition is performed in alternation to the bands of semiconductor oxide film over the same substrate and said irradiating step is performed by rastering the laser beam over said catalyst precursor paste or precursor solution layer in alternation to said bands of semiconductor oxide film.

15. The process of manufacturing the catalytic layer of counter-electrodes of dye-sensitized solar cells according to claim 14, further comprising, after said step of sintering said semiconductor oxide colloidal paste and before said step of applying a dye monolayer to the semiconductor oxide film, further step of treating said semiconductor oxide film, such as TiCl₄ and UV—O₃ treatments.
